(19) United States
(12) Patent Application Publication
(10) Pub. No.: US 2014/0261310 A1
(43) Pub. Date: Sep. 18, 2014

(54) SYSTEM AND METHOD TO OPTIMIZE ENGINE BRAKING POWER

(71) Applicant: CATERPILLAR INC., Peoria, IL (US)

(72) Inventors: Keith N. E. Troisi, Washington, IL (US); Travis E. Barnes, Metamora, IL (US); Alexandra L.V. Santos, Peoria, IL (US); Inderbir Dhillon, Dearborn, MI (US); Stephan Roozenboom, Washington, IL (US)

(73) Assignee: Caterpillar Inc., Peoria, IL (US)

(21) Appl. No.: 13/836,232

(22) Filed: Mar. 15, 2013

(51) Int. Cl. F02D 9/00

(52) U.S. Cl. CPC F02D 9/00
USPC 123/324

(57) ABSTRACT

A system for optimizing engine braking power is provided. The system includes an intake manifold configured to receive air from a compressed air source. The system includes an engine brake associated with a power source. The system also includes a bleed valve configured to bleed a portion of the air from the intake manifold. The system further includes a controller in communication with the bleed valve and configured to receive a status of the engine brake. The controller is configured to activate the bleed valve to bleed a portion of the air from the intake manifold based at least in part on the engine brake being active and based at least in part on a pre-determined relationship between an air pressure in the intake manifold and one or more parameters associated with the power source.

### TECHNICAL FIELD

The present disclosure relates to a system and a method of engine braking in an internal combustion engine, and more specifically to a system and a method for optimizing engine braking power in the internal combustion engine.

### BACKGROUND

Internal combustion engines may experience operational issues like floating of exhaust valves during engine braking. At certain engine speeds, during a compression stroke of a piston, the pressure build up in a cylinder of the internal combustion engine may cause untimely opening of the exhaust valve and thus leading to valve floating. Valve floating may induce detrimental overpressure condition in an associated brake housing designed for appropriate functioning of the valves, many a times which may lead to complete failure of the exhaust valve assembly.

The pressure build up in the cylinders of the engine is directly related to the intake manifold air pressure. Means to regulate the intake manifold air pressure to prevent over loading on engine components is known in the art. For example, U.S. Pat. No. 4,688,384 provides a method and an apparatus, during compression engine braking of an internal combustion engine, for controlling the intake manifold air pressure to control the magnitude of engine braking power and loads imposed on certain engine components.

However, the known systems do not facilitate maximizing the engine braking power at the time of limiting the intake manifold air pressure. Hence, there is a need of an improved system and a method that could prevent valve floating while still maximizing the engine braking power.

### SUMMARY OF THE DISCLOSURE

In one aspect of the present disclosure, a system for optimizing engine braking power is provided. The system includes an intake manifold configured to receive air from a compressed air source. The system includes an engine brake associated with a power source. The system also includes a bleed valve configured to bleed a portion of the air from the intake manifold. The system further includes a controller in communication with the bleed valve. The controller is further configured to receive a status of the engine brake. The controller is configured to activate the bleed valve to bleed a portion of the air from the intake manifold based at least in part on the engine brake being active and based at least in part on a pre-determined relationship between an air pressure in the intake manifold and one or more parameters associated with the power source.

In another aspect of the present disclosure, a method for optimizing engine braking power is provided. The method receives a signal indicative of a status of an engine brake associated with a power source. The method receives a signal indicative of one or more operational parameters of the power source. The method also receives a signal indicative of an air pressure in an intake manifold. The method further controls a bleed valve configured to bleed a portion of the air from the intake manifold based at least in part on the status of the engine brake, and based at least in part on a pre-determined relationship between the air pressure in the intake manifold and one or more parameters associated with the power source.

Other features and aspects of this disclosure will be apparent from the following description and the accompanying drawings.

### BRIEF DESCRIPTION OF THE DRAWINGS

FIG. 1 is an exemplary machine, according to one aspect of the present disclosure;

FIG. 2 is a sectional view of an engine brake embodiment;

FIG. 3 is a diagrammatic view of an exhaust system of the machine; and

FIG. 4 is a method to optimize engine braking power.

### DETAILED DESCRIPTION

Wherever possible, the same reference numbers will be used throughout the drawings to refer to the same or the like parts. FIG. 1 illustrates a machine 100. The machine 100 may be one of various types of machinery used in a number of industries such as mining, agriculture, construction, forestry, waste management, a passenger machine and material handling. Although, the machine 100 is shown as a truck, the machine 100 could be any type of a mobile machine having an exhaust producing power source. The machine 100 may include a frame or a chassis 102. An operator station 104, a drivetrain 106, and a brake mechanism 108 may be provided on the chassis 102 of the machine 100. The drivetrain 106 and the brake mechanism 108 may be controlled by way of the operator station 104.

The operator station 104 may receive input from an operator indicative of a desired function of the machine 100. The operator station 104 may include an operator interface 109 having one or more control devices such as a throttle pedal (not shown) to control a speed or torque of the drivetrain 106, a brake pedal (not shown) to control operations of the brake mechanism 108, a steering wheel (not shown) to control an orientation of the machine 100, and a gear selector (not shown) associated with ratio control of the drivetrain 106. The operator interface 109 may embody a proportional or an on/off-type controller such as, for example, single or multi-axis joysticks, wheels, knobs, push-pull devices, switches, and other operator interface devices known in the art.

The drivetrain 106 may include a power source 110, a torque converter 112, a transmission 114, and one or more traction devices 116. The power source 110 may transmit power through the torque converter 112 to the transmission 114 and from the transmission 114 to the traction devices 116 through a shaft 118.

The torque converter 112 may be a hydro-mechanical device configured to couple the power source 110 to the transmission 114. In particular, the torque converter 112 may conduct pressurized fluid between an output of the power source 110 and an input of the transmission 114 to thereby drive the transmission 114, while still allowing the power source 110 to rotate somewhat independently of the transmission 114. In addition, the torque converter 112 may include a lockup clutch (not shown) for directly mechanically coupling the output of the power source 110 to the input of the transmission 114. In this arrangement, the torque converter 112 may selectively absorb and multiply the torque transferred between the power source 110 and the transmission 114 by either allowing or preventing slippage between the output rotation of the power source 110 and the input rotation of the transmission 114. It is further contemplated that the torque converter 112 may alternatively embody a non-hydraulic device such as, for example, a mechanical diaphragm clutch.

The transmission 114 may include numerous components that interact to transmit power from the torque converter 112 to the traction device 116. In particular, the transmission 114 may embody a multi-speed, bidirectional, mechanical transmission having a neutral gear ratio, a plurality of forward gear ratios, a reverse gear ratio, and one or more clutches (not shown). The clutches may be selectively actuated to engage pre-determined combinations of gears (not shown) that produce a desired output gear ratio. The transmission 114 may be an automatic-type transmission, wherein shifting may be based on a power source speed, a maximum selected gear ratio, and a shift map stored within a transmission controller. Alternatively, the transmission 114 may be a manual-type transmission, wherein selection of each gear ratio is performed directly by the operator. The output of the transmission 114 may be connected to rotatably drive the traction device 116 via the shaft 118, thereby propelling the machine 100.

The traction device 116 may include wheels located on each side of the machine 100 (only one side shown). Alternately, the traction device 116 may include tracks, belts, or other driven traction devices. The traction device 116 may be driven by the transmission 114 to rotate in accordance with an output rotation of the transmission 114.

The brake mechanism 108 may retard the motion of the machine 100 and may be operably associated with each of the traction device 116 of the machine 100. In one embodiment, the brake mechanism 108 may embody a hydraulic pressure-actuated wheel brake such as, for example a disk brake or a drum brake, as is commonly known in the art. It is contemplated that the brake mechanism 108 may alternatively embody another non-hydraulic type of wheel brake such as an electric motor or any other similar mechanism known in the art.

The power source 110 may be any kind of a power source known in the art that combusts fuel and air to produce power and a flow of exhaust gases. For example, the power source 110 may be an internal combustion engine, such as a gasoline engine, a diesel engine, a natural gas engine or any other exhaust producing engine. The power source 110 may further include an engine brake 122 that may use compressed air from an induction system 120 to slow the machine 100. The power source 110 may direct a flow of exhaust gas to atmosphere through an exhaust system 124.

The induction system 120 may include a means for introducing air required for combustion into the power source 110. For example, the induction system 120 may include a compressed air source like a compressor 126 in fluid communication with the power source 110 via an intake manifold 128. The compressor 126 may compress the air flowing into the power source 110 to a pre-determined pressure level and direct the compressed air to the power source 110 via the intake manifold 128. It is contemplated that additional and/or different components may be included within the induction system 120 such as, for example, an air cooler, a bypass valve, a throttle valve, an air cleaner, a pressure relief device, and other means known in the art for introducing air into the power source 110. The exhaust system 124 may include an exhaust manifold, a regeneration unit and an after-treatment device which will be explained in detail in connection with FIG. 2 and FIG. 3. Further, the machine 100 may include a controller 130 that may be communicably coupled with the induction system 120, the power source 110, and the exhaust system 124. The controller 130 may also be configured to receive a status of the engine brake 122.

As illustrated in FIG. 2, the power source 110 may employ the engine brake 122. The engine brake 122 may cooperate with the power source 110 to decelerate the machine 100. The engine brake 122 may be any type of an engine brake known in the art configured to selectively increase the natural resistance of the power source 110 against the motion of the machine 100. In one embodiment, the engine brake 122 may be a compression engine brake. The engine brake 122 may include an actuator 202 configured to open an exhaust valve 204 of a cylinder 206 of the power source 110 near a top dead center (TDC) position 208 during a compression stroke of an associated piston 210. By opening the exhaust valve 204 near the TDC position 208, highly compressed air may exit the cylinder 206, thereby removing stored energy from the piston 210. On an ensuing downward power stroke, essentially no energy is returned to the piston 210 and further to the traction device 116 via the transmission 114, resulting in a deceleration of the machine 100. It should be noted that the engine brake 122 may be hydraulically operated, mechanically operated, electrically operated, pneumatically operated, or operated in any other suitable manner.

In another alternative embodiment, the engine brake 122 may be a constant lift type engine brake. In such an arrangement, during engine braking, the actuator 202 may operate similarly to the embodiment described in connection to the compression engine brake, except that the actuator 202 may be used to prevent the exhaust valve 204 from fully closing, thereby maintaining exhaust valve 204 in an open position at all or nearly all times. Under such operation, the actuator 202 may create a small gap, for example, a one millimeter gap, between the exhaust valve 204 and a valve seat (not shown). Such an arrangement may provide sufficient engine braking power, but with a lower noise level than that associated with the compression engine brake embodiment as described above.

Alternatively, the engine brake 122 may be an exhaust type engine brake. In the exhaust type engine brake embodiment, a restriction valve 212 may be disposed within an exhaust manifold 214 of the exhaust system 124 to restrict the flow of the exhaust gases exiting the power source 110. The restricted flow of the exhaust gases may cause a backup of pressure within the cylinder 208 of the power source 110 which may increase the work that the piston 210 must perform during the compression and the exhaust strokes. The increasing backpressure may result in the deceleration of the machine 100.

In an embodiment of the disclosure, the engine brake 122 may include a brake controller 216. The brake controller 216 may be configured to control the actuator 202 to activate or deactivate the engine brake 122, based on one or more parameters related to the power source 110. The brake controller 216 may be coupled to the engine brake 122 via a communication line 217 to send actuation signals to the engine brake 122. The brake controller 216 may be communicably coupled with the operator interface 109 via a communication line 218 to receive signals indicative of various operator commands associated with the machine 100. In an embodiment, when an operator may provide a command through the operator interface 109 to activate the engine brake 122, the brake controller 216 may determine if the engine brake 122 needs to be actuated based on one or more parameters. The one or more parameters may include, but not limited to, a signal indicative of a throttle command from the operator interface 109. For example, if the machine 100 is travelling uphill, and the operator inputs an activation of the engine brake 122, the brake controller 216 may check the throttle command. In an event of the throttle command is beyond a predetermined threshold, the brake controller 216 may not actuate the engine brake 122. The brake controller 216 may monitor the throttle command in real time and may activate the engine brake 122 as the throttle command falls below the predetermined threshold.

In various other embodiments, as illustrated in FIG. 2, the brake controller 216 may also be coupled to a power source speed sensor 219 via a communication line 220 to receive signals indicative of an operational speed of the power source 110, to a travel speed sensor 222 via a communication line 224 to receive signals indicative of a linear speed of the machine 100, to an intake manifold pressure sensor 226 via a communication line 228 to receive signals indicative of air pressure in the intake manifold 128. The brake controller 216 may be configured to activate the engine brake 122 based on one or more inputs commonly known in the art and the maps stored in a memory of the brake controller 216. For example, the brake controller 216 may monitor the speed sensor 219, the travel speed sensor 222, the operation of the power source 110, the pressure sensor 226 and the operator input received via the operator interface 109, and, based on the data contained in the maps, determine that the machine 100 may require more braking power in addition to the braking power provided by the brake mechanism 108. Based on this determination, the brake controller 216 may activate the engine brake 122. The brake controller 216 may then monitor the operating status of the engine brake 122, input from the speed sensor 219, the travel speed sensor 222, the pressure sensor 226, the operator interface 109, other measured parameters of the power source 110, and other sensors known in the art, to determine, for example, a duration of an activation of the engine brake 122, whether the engine brake 122 should be adjusted to provide more or less braking, and/or whether the engine brake 122 should be deactivated.

In an embodiment, the brake controller 216 may be communicably coupled with the controller 130, and the brake controller 216 may provide a signal indicative of a status of the engine brake 122 to the controller 130. In various other embodiments, the brake controller 216 may be integrated with the controller 130 and is configured to actuate the engine brake 122, based on the one or more parameters as explained above.

FIG. 3 illustrates the induction system 120 and the exhaust system 124 in an exemplary embodiment of the present disclosure. As explained earlier in conjunction with FIG. 2, the controller 130 is configured to open the exhaust valve 204. It may be apparent to a person skilled in the art that a force required to open the exhaust valve 204 during engine braking may be determined as shown in the following Equation 1 below:

Force_{Valve Open}=P_{cyl}*Area_{Valve Cyl}−Pₑₓₕ*Area_{Valve Exh}+F_{Spring} eq. (1)

### Where:

Force_{Valve Open}=Force required to open the exhaust valve
P_{cyl}=Cylinder Pressure
Pₑₓₕ=Exhaust Manifold Pressure
Area_{Valve Cyl}=Exhaust Valve Area on the cylinder side
Area_{Valve Exh}=Exhaust Valve Area on the exhaust manifold side
F_{Spring}=Constant Spring Force of the exhaust valve
   It is apparent that the force required to open the exhaust valve 204 is directly related to the cylinder pressure. Further, the cylinder pressure is related to the air pressure in the intake manifold 128 (that receives compressed air from the compressor 126) as follows:

P_{cyl}=Pᵢₙ(CR)^{k} eq. (2)

### Where,

P_{cyl}=Cylinder Pressure
Pᵢₙ=Air Pressure in Intake Manifold
CR=Compression Ratio at the piston position under consideration
k=Ratio of specific heats (Cₚ/Cᵥ)
   Since the instantaneous compression ratio and the ratio of specific heats are fixed for a particular engine during engine braking when only air is being compressed, there is a direct relation between the cylinder pressure and air pressure in the intake manifold 128. Therefore, controlling the air pressure in the intake manifold 128 may in turn control the cylinder pressure inside the cylinder 206 and thus, effects the force required to open the exhaust valve 204.

As illustrated in FIG. 3, the induction system 120 may also include a bleed line 302 from the intake manifold 128. The bleed line 302 may further include a bleed valve 304 configured to a control a flow of air from the bleed line 302. The bleed valve 304 may include any valve that controls the flow of air, and that can move to any position between a closed position and an open position. The bleed valve 304 may be a butterfly valve, a gate valve, a ball valve, a globe valve, a diaphragm valve or any other type of valve known in the art for providing control of flow of air. In another embodiment, the bleed valve 304 may include a three way valve and is configured to select at least one of atmosphere, regeneration system or other low pressure auxiliary devices associated with the power source 110 to bleed-off a portion of the air from the intake manifold 128. The bleed valve 304 may further be mechanically, electrically, hydraulically and/or pneumatically operated with or without an actuator.

In an embodiment of the disclosure, the bleed valve 304 may be communicably coupled to the controller 130 via a communication line 307 and the controller 130 may send actuation signals to the bleed valve 304 to bleed a portion of the compressed air. In various embodiments of the disclosure, the controller 130 may receive signals indicative of the air pressure in the intake manifold 128 from the pressure sensor 226, signals indicative of one or more parameters of the power source 110, and a signal via a communication line 308 from the brake controller 216 indicative of the operational status of the engine brake 122 to enable the controller 130 to determine whether the bleed valve 304 needs to be actuated. Additional sensors may be employed and coupled communicably to the controller 130, other than ones described herein, to communicate a variety of other operational parameters to the controller 130.

Based on the signals received by the controller 130, the controller 130 may retrieve data from a database. In one embodiment, the database may be intrinsic to the controller 130 and integrated in its memory. In another embodiment, the database may be extrinsic to the controller 130 and may be any conventional or non-conventional database, like an oracle database, known to one skilled in the art. The database may be capable of storing and/or modifying pre-stored and/or adding completely new data unknown to the database. The data may be stored in the database in the form of one or more maps that describe and/or relate operation of the bleed valve 304 based on one or more parameters of the power source 110. Each of these maps may be in the form of tables, graphs, and/or equations, and include a compilation of data collected from lab and/or field operation of the power source 110 and the engine brake 122 and/or other systems. The maps may be generated by performing instrumented tests on the operation of the power source 110, the engine brake 122, and/or the regeneration unit 306 under a variety of operating conditions. The controller 130 may compare the signals received from the power source 110 regarding the various operational parameters of the power source 110, the pressure sensor 226 and the engine brake 122 with the map data and, accordingly, send operational signals to the bleed valve 304.

In one embodiment, the data stored in the database may be a map configured in the form of a table having permissible air pressure values in the intake manifold 128 for varying operational speeds of the power source 110. The controller 130 may receive signals indicative of the air pressure in the intake manifold 128 and the operational speed of the power source 110 from the pressure sensor 226 and the speed sensor 219, respectively. The controller 130 may then compare the received signals to the map stored in the database. Based on the comparison made, the controller 130 may be configured to determine an area of the bleed valve 304 to be opened to bleed-off a portion of the compressed air. Based on the determination, the controller 130 may send signals to the bleed valve 304 to bleed off the portion of the compressed air from the intake manifold 128. The controller 130 may also be further configured to deactivate the actuation of the bleed valve 304 when the permissible air pressure value in the intake manifold 128 may be achieved.

Though, the above embodiment is explained with respect to controlling the actuation of bleed valve 304 based on the operational speed of the power source 110 and the air pressure in the intake manifold 128, it does not limit the scope of the disclosure. In various other embodiments, the controller 130 may actuate the bleed valve 304 based on other data tables or maps providing a relation between the permissible air pressure in the intake manifold 128 for various operational parameters, such as, but not limited to temperature, altitude, and inlet and outlet exhaust restrictions etc.

In one embodiment, the bleed line 302 may vent the bleed air to the atmosphere without diverting the bleed air to any device or a system. In another embodiment, the bleed line 302 may be configured to divert the bleed air from the intake manifold 128 to the regeneration unit 306, as illustrated in FIG. 3. In yet another embodiment, the bleed air may also be diverted to other low pressure regions other than the regeneration unit 306, for example, other exhaust system devices that rely on air for effective operation, components of a cabin climate control system for operator station, supplemental or auxiliary air reservoirs for brake mechanism, windshield wipers, and air operated suspension components and the like.

The regeneration unit 306 may intrinsically or extrinsically embody an after-treatment device 309. The exhaust manifold 214 may direct the exhaust gas flow from the power source 110 through the after-treatment device 309 to the atmosphere. The after-treatment device 309 may be any type of a device configured to remove one or more constituents from the exhaust gases of the power source 110, and which may be periodically regenerated by the regeneration unit 306. In one embodiment, the after-treatment device 309 may include a particulate trap or a diesel particulate filter.

Alternatively or additionally, the after-treatment device 309 may include any one or a combination of a catalytic converter, a catalyzed particulate trap, a NOx adsorber, or any other type of after-treatment device that may be regenerated or requires a rise in temperature for proper operation. For example, the after-treatment device 309 may include a particulate trap and a catalytic converter disposed in series, which, in some embodiments, may be integrated into the same unit.

The after-treatment device 309 may require regular thermal regeneration by the regeneration unit 306. The regeneration unit 306 may be positioned anywhere along the exhaust system 124 between the power source 110 and the after-treatment device 309 to directly raise the temperature of the exhaust gases exiting the power source 110. The regeneration unit 306 may include a fuel injector 310 configured to inject fuel into the exhaust flow, a supply of pressurized air configured to mix with the exhaust gases and the injected fuel, and an ignition source 312 configured to ignite the mixture. The controller 130 may be communicably coupled to the fuel injector 310 and the ignition source 312 by a communication line 314 and a communication line 316, respectively. The pressurized air may be a combination of compressed air from the compressor 126 of the induction system 120 and the bleed air supplied by the bleed valve 304 provided in the bleed line 302 of the intake manifold 128. In one embodiment, the pressurized air may only be the compressed air from the compressor 126 of the induction system 120, when the bleed air may be directly vented to the atmosphere. The ignition source 312 may include a spark plug, a heater, a glow plug or any other means for igniting the mixture of the fuel and the pressurized air. Ignition of the mixture of the fuel and the pressurized air may raise the temperature of the exhaust gases to such a pre-determined temperature so as to burn away the residue and/or debris trapped in the after-treatment device 309, thus causing regeneration of the after-treatment device 309.

In one embodiment, the regeneration unit 306 may use a heated nozzle tip (not shown) on the fuel injector 310 to keep the tip clean from coking over time. The nozzle may be required to undergo a heating cycle, after a pre-determined number of regeneration operations, to remove coking and other undesired depositions, if any. The heating cycle may be performed by an electric heater (not shown) configured to heat the nozzle for a pre-determined amount of time. When the heating cycle is in progress, it may be undesirable to bleed-off the excess air from the intake manifold 128 to the regeneration unit 306, as the bleed air may cause the nozzle temperature to drop below the pre-determined value and the nozzle may fail to be cleaned appropriately. In an embodiment, the controller 130 may be communicably coupled to the fuel injector 310, and may receive signals indicative of an active heating cycle. Based on the active heating cycle signal, the controller 130 may be configured to communicate a signal to the bleed valve 304 to bleed-off the portion of the air to the atmosphere or other auxiliary devices instead of the regeneration unit 306.

The controller 130 may embody a single microprocessor or multiple microprocessors that includes a means for receiving signals from the plurality of power source 110 sensors in order to determine the various operational parameters associated with the power source 110. Numerous commercially available microprocessors may be configured to perform the functions of the controller 130. It should be appreciated that the controller 130 may readily embody a general power source 110 microprocessor capable of controlling and/or monitoring numerous power source 110 parameters. A person of ordinary skill in the art will appreciate that the controller 130 may additionally include other components and may also perform other functionalities not described herein. Further, the connections and sensors described herein are merely on an exemplary basis and may not limit the scope of the disclosure.

### INDUSTRIAL APPLICABILITY

The engine brake may present a number of operational issues while being operated within a certain range of operational parameters including, but not limited to, engine speed, cylinder pressure, intake manifold pressure and the like. The present disclosure is related to one such operational issue being floating of the exhaust valve. During engine braking, the exhaust valve is configured to open and exhaust the highly compressed air at a pre-determined time of the compression stroke, that is, just before the end of the compression stroke near the TDC position of the piston. But, at certain engine speeds, during the compression stroke of the piston, the pressure build up in the cylinder of the power source may be so high that the exhaust valve may tend to open before the desired opening time. This unexpected event of early opening of the exhaust valve may be termed as valve floating. Valve floating creates a reverse pressure on the actuator and other valve actuating mechanism in the brake housing, thus, inducing an overpressure condition in the associated brake housing designed for appropriate functioning of the valves. Valve floating may pose a serious threat to the exhaust valve as it may cause considerable damage to the exhaust valve itself and further leading to catastrophic failure of the brake housing and in turn the overall power source assembly. Hence, it is desired to control the cylinder pressure up to a limit where the valve floating may not occur while still maximizing the engine braking power.

The present disclosure relates to a system and a method to ensure prevention of valve floating while optimizing engine braking power in internal combustion engines during engine braking. Also, in an embodiment the system and the method may provide a reliable way to optimize the operation of a performance enhancing subsystem, specifically an engine brake, while ensuring optimum operating capability for an interrelated performance enhancing subsystem, such as a regeneration unit and/or an after-treatment device and the like.

Atmospheric air may be drawn into the compressor 126 where it may be pressurized to a pre-determined level. Upon exiting the compressor 126, the main portion of the compressed air from the compressor 126 may pass through the intake manifold 128 to the power source 110. Fuel may be mixed with the compressed air entering the power source 110, and combusted to produce mechanical work and an exhaust flow. The exhaust flow may be directed from the power source 110 through the exhaust manifold 214 and the after-treatment device 309, finally exiting to the atmosphere.

Further, the brake controller 216 is configured to control the actuator 202 to activate or deactivate the engine brake 122, based on one or more parameters related to the power source 110. In an embodiment, when an operator may provide a command through the operator interface 109 to activate the engine brake 122, the brake controller 216 may determine if the engine brake 122 needs to be actuated based on a throttle command from the operator interface 109. For example, if the machine 100 is travelling uphill, and the operator inputs an activation of the engine brake 122, the brake controller 216 may check the throttle command. In an event of the throttle command is beyond a predetermined threshold, the brake controller 216 may not actuate the engine brake 122. The brake controller 216 may monitor the throttle command in real time and may activate the engine brake 122 as the throttle command falls below the predetermined threshold.

In various other embodiments, the brake controller 216 may also be coupled to the power source speed sensor 219 to receive signals indicative of an operational speed of the power source 110, to the travel speed sensor 222 to receive signals indicative of a linear speed of the machine 100, to the intake manifold pressure sensor 226 to receive signals indicative of air pressure in the intake manifold 128. The brake controller 216 may be configured to activate the engine brake 122 based on one or more inputs commonly known in the art and the maps stored in a memory of the brake controller 216. For example, the brake controller 216 may monitor the speed sensor 219, the travel speed sensor 222, the operation of the power source 110, the pressure sensor 226 and the operator input received via the operator interface 109, and, based on the data contained in the maps, determine that the machine 100 may require more braking power in addition to the braking power provided by the brake mechanism 108. Based on this determination, the brake controller 216 may activate the engine brake 122. The brake controller 216 may then monitor the operating status of the engine brake 122, input from the speed sensor 219, the travel speed sensor 222, the pressure sensor 226, the operator interface 109, other measured parameters of the power source 110, and other sensors known in the art, to determine, for example, a duration of an activation of the engine brake 122, whether the engine brake 122 should be adjusted to provide more or less braking, and/or whether the engine brake 122 should be deactivated.

When the controller 130 activates the engine brake 122, the controller 130 may modulate the actuator 202 to open the exhaust valve 204 of the power source 110 near the TDC position 208 of the piston 210. During engine braking, the kinetic energy of the machine 100 may be transmitted through the traction device 116, the shaft 118, the transmission 114, the torque converter 112, and the power source 110 to the piston 210, where it may be converted into pressurized air and heat within the cylinder 206 of the power source 110, then exhausted to the atmosphere, thereby slowing the machine 100. In an embodiment, the brake controller 216 may be communicably coupled with the controller 130, and the brake controller 216 may provide a signal indicative of a status of the engine brake 122 to the controller 130. In various other embodiments, the brake controller 216 may be integrated with the controller 130 and is configured to actuate the engine brake 122, based on one or more parameters as explained above.

Accordingly, referring to FIG. 400, at step 402, the controller 130 may receive signals from the engine brake 122 indicative of the operational status of the engine brake 122. At step 404, the controller 130 may receive signals indicative of one or more operational parameters, related to the power source 110, from the various sensors associated with the power source 110. For example, the controller 130 may receive signals indicative of the operational speed of the power source 110 from the speed sensor 219.

At step 406, the controller 130 may receive signals indicative of the air pressure in the intake manifold 128 from the pressure sensor 226. Based on the received signals, the controller 110 may compare the signal data, received from the various sensors associated with the power source 110, with the data present in the map stored in the memory of the controller 130. In one embodiment, the map may store data pertaining to a relation between the maximum permissible air pressures in the intake manifold 128 at varying operational speeds of the power source 110 designed to maximize the engine braking power. In other words, the relation may be such that the maximum permissible air pressure for each of a range of the operational speed of the power source 110 may be permitted to be as high as possible, to maximize engine braking power, but simultaneously being low enough to prevent valve floating of the exhaust valve 204, due to excessive pressure build up inside the cylinder 206.

On the comparison analysis made by the controller 130, at step 408, the controller 130 may send actuation signals to the bleed valve 304. The signals may be based on the operating status of the engine brake 122 as well as the pre-determined relationship between the air pressure in the intake manifold 128 and one or more parameters associated with the power source 110 like the operational speed of the power source 110. The actuation signals may appropriately control the bleed valve 304 so as to accurately bleed a portion of compressed air from the intake manifold 128 in order to avoid a short or an excess amount of air to bleed off from the intake manifold 128, mainly to maximize engine braking power.

For example, if the controller 130 detects the actual air pressure in the intake manifold 128 determined by the pressure sensor 226 at a certain operational speed of the power source 110 to be greater than the permissible air pressure in the intake manifold 128 stored in the map at the same operational speed, the controller 130 may send actuation signals to the bleed valve 304 indicative of regulating the bleed valve 304 and bleeding a pre-determined amount of air. When the air pressure in the intake manifold 128 drops to the permissible limit as stored in the map, the controller 130 may again send actuation signals to the bleed valve 304 indicative of regulating the bleed valve 304 to control/deactivate the bleeding of air pressure in the intake manifold 128.

Though, the step 408 is explained with respect to controlling the actuation of bleed valve 304 based on the speed of the power source 110 and the air pressure in the intake manifold 128, it does not limit the scope of the disclosure. For example, the controller 130 may receive signals from various other sensors associated with the power source 110, indicative of parameters including, but not limited to, temperature, altitude, inlet and outlet exhaust restrictions and the like. Accordingly, the controller 130 may control the bleed valve 304 based on other data tables or maps providing a relationship between the permissible air pressure value in the intake manifold 128 to the parameters such as, but not limited to, temperature, altitude, inlet and outlet exhaust restrictions.

The bleed air released by the bleed valve 304 in the bleed line 302 may be vented to the atmosphere in one embodiment. Alternatively, the bleed air may be diverted to the regeneration unit 306. In the regeneration unit 306, the bleed air may be utilized for raising the temperature of the exhaust gases by combustion of the fuel injected in the exhaust gas stream. The hot exhaust gases may then be directed to the after-treatment device 309 to burn out the residue and/or the debris to perform regeneration of the after-treatment device 309.

The strategy implemented by the controller 130 to regulate the subsystems of the power source 110 may result in a more efficient and effective system. For example, the disclosed system and method may allow maximum engine braking power, while also providing effective regeneration of the after-treatment device 309 during normal operating conditions when necessary.

The strategy implemented by the controller 130 to regulate the subsystems of the power source 110 is described in this disclosure as being useful for controlling interaction between the engine brake 122 and the regeneration unit 306, and it is further contemplated that similar strategies may be advantageous for interactions between the engine brake 122 and other auxiliary devices or subsystems that may rely on a source of air shared with the engine brake 122. A similar strategy may be used to allow effective operation of such a device or subsystem under normal operating conditions, and to provide maximum engine braking power when necessary.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for optimizing engine braking power, the system comprising:
an intake manifold configured to receive air from a compressed air source;
an engine brake associated with a power source;
a bleed valve configured to bleed a portion of the air from the intake manifold, and
a controller in communication with the bleed valve and configured to receive a status of the engine brake, the controller being configured to activate the bleed valve to bleed a portion of the air from the intake manifold based at least in part on the engine brake being active and based at least in part on a pre-determined relationship between an air pressure in the intake manifold and one or more parameters associated with the power source.

2. The system of claim 1, wherein the one or more parameters include at least one of an engine speed, temperature, altitude, inlet and outlet exhaust restrictions.

3. The system of claim 1, wherein the bleed valve is configured to bleed the portion of the air from the intake manifold to at least one of the atmosphere or auxiliary devices.

4. The system of claim 1, wherein the bleed valve is configured to bleed the portion of the air to a regeneration unit, wherein the regeneration unit is configured to regenerate an after-treatment device.

5. The system of claim 4, wherein the regeneration unit comprises a fuel injector having a nozzle tip, and wherein the nozzle tip is configured to undergo a heating cycle after a pre-determined number of regeneration cycles.

6. The system of claim 5, wherein during the heating cycle the bleed valve is configured to bleed the portion of the air to a low pressure region other than the regeneration unit.

7. The system of claim 1, wherein the bleed valve comprises a three way valve.

8. The system of claim 1 further comprises a pressure sensor communicably coupled to the controller, wherein the pressure sensor is configured to generate a signal indicative of an air pressure in the intake manifold.

9. The system of claim 1, wherein the controller is configured to activate the engine brake based at least in part on an operational speed of the power source.

10. A method for optimizing engine braking power, the method comprising:
receiving a signal indicative of a status of an engine brake associated with a power source;
receiving a signal indicative of one or more operational parameters of the power source;
receiving a signal indicative of an air pressure in an intake manifold;
controlling a bleed valve configured to bleed a portion of the air from the intake manifold based at least in part on the status of the engine brake, and based at least in part on a pre-determined relationship between the air pressure in the intake manifold and one or more parameters associated with the power source.

11. The method of claim 10, wherein the one or more parameters include at least one of an engine speed, temperature, altitude, inlet and outlet exhaust restrictions.

12. The method of claim 10 further comprising bleeding the portion of the air from the intake manifold to at least one of the atmosphere and auxiliary devices.

13. The method of claim 10 further comprising bleeding the portion of the air from the intake manifold to a regeneration unit, wherein the regeneration unit is configured to regenerate an after-treatment device.

14. The method of claim 10 further comprising controlling the engine brake based at least in part on an operational speed of the power source.

15. A machine comprising:
a power source;
one or more traction devices configured to receive power through the power source;
an intake manifold configured to receive air from a compressed air source;
an engine brake associated with the power source, the engine brake configured to reduce a speed of the power source;
a bleed valve configured to bleed a portion of the air from the intake manifold, and
a controller in communication with the bleed valve and configured to receive a status of the engine brake, the controller being configured to activate the bleed valve to bleed a portion of the air from the intake manifold to the regeneration unit based at least in part on the engine brake being active and based at least in part on a pre-determined relationship between an air pressure in the intake manifold and one or more parameters associated with the power source.

16. The machine of claim 15, wherein the bleed valve is a three way valve.

17. The machine of claim 16, wherein the bleed valve is configured to select at least one of the regeneration unit, atmosphere and other low pressure regions to bleed the portion of the air from the intake manifold.

18. The machine of claim 15, wherein the regeneration unit is configured to regenerate an after-treatment device.

19. The machine of claim 18, wherein the regeneration unit comprises a fuel injector having a nozzle tip, and wherein the nozzle tip is configured to undergo a heating cycle after a pre-determined number of regeneration cycles.

20. The machine of claim 19, wherein during the heating cycle, the bleed valve is configured to bleed the portion of the air to a low pressure region other than the regeneration unit.
